(19) United States
(12) Patent Application Publication
(10) Pub. No.: US 2014/0174094 A1
(43) Pub. Date: Jun. 26, 2014

(54) APU Exhaust Housing Perforated Ring

(71) Applicant: UNITED TECHNOLOGIES CORPORATION, Hartford, CT (US)

(72) Inventors: Jon Szymanski, West Hartford, CT (US); Farooq Rehman, San Diego, CA (US); Ara J. Hovhannisian, Poway, CA (US); Anthony C. Jones, San Diego, CA (US)

(73) Assignee: United Technologies Corporation, Hartford, CT (US)

(21) Appl. No.: 13/724,954

(22) Filed: Dec. 21, 2012

(51) Int. Cl. F02C 7/00

(52) U.S. Cl. CPC F02C 7/00
USPC 60/772; 60/39.5

(57) ABSTRACT

According to one embodiment of the present disclosure, an exhaust apparatus for an auxiliary power unit is disclosed. The exhaust apparatus may include an exhaust housing including a perforated body surrounding an exhaust airflow of the auxiliary power unit. The perforated body may include an outer surface, an inner surface, and a plurality of holes through which ambient air passes to mix with the exhaust airflow, the plurality of holes extending through the body from the outer surface to the inner surface.

### FIELD OF THE DISCLOSURE

The present disclosure relates generally to auxiliary power units and, more particularly, to an exhaust housing for an auxiliary power unit.

### BACKGROUND OF THE DISCLOSURE

Large commercial aircraft typically include on-board auxiliary power units (APUs) located in the tail sections of the aircraft to provide electrical power and compressed air for systems throughout the aircraft. APUs typically comprise gas turbine engines having a compressor and a turbine, between which a combustor burns fuel. Through a gearbox, the turbine provides mechanical input to an electrical generator, while compressed air bled from the compressor is used to supply various environmental controls.

For example, when an aircraft is on the ground, the primary propulsion engines of the aircraft are shut down, and the APU provides the main source of power for a variety of systems, such as the environmental control systems, hydraulic pumps, electrical systems, and main engine starters. The APU may also provide power during in-flight operations, such as for electrical and pneumatic systems.

In many gas turbine engine applications, particularly those in which the engine is used in conjunction with a commercial passenger aircraft, there is a widespread demand by the airline industry to maintain noise levels below defined limits. This is particularly important at ground service stations for the aircraft, where ground crew load and unload luggage fuel and provision the aircraft, and remove waste materials from the aircraft. Under these conditions, the aircraft APU is the turbine engine of interest.

One technique for attenuating the exhaust noise of an APU involves placing an exhaust silencer directly downstream from the APU exhaust diffuser. However, combustion gases exit the APU at high velocities and create a turbulent mixing downstream from the exhaust diffuser. This is particularly true when cooling air from an eductor mixes with the combustion gases. The turbulent mixing generates a substantial amount of additional noise downstream from the exhaust diffuser. Thus, there exists a need for a way to reduce noise created by the exhaust of an APU.

### SUMMARY OF THE DISCLOSURE

According to one embodiment of the present disclosure, an exhaust apparatus for an auxiliary power unit is disclosed. The exhaust apparatus may comprise an exhaust housing including a perforated body surrounding an exhaust airflow of the auxiliary power unit. The perforated body may include an outer surface, an inner surface, and a plurality of holes through which ambient air passes to mix with the exhaust airflow, the plurality of holes extending through the body from the outer surface to the inner surface.

In a refinement, the perforated body may be generally cylindrical in shape.

In a related refinement, the plurality of holes may be arranged in at least one row around a circumference of the perforated body such that the at least one row admits ambient airflow to penetrate all sides of the exhaust airflow, each of the plurality of holes providing the ambient airflow in a radially inward direction.

In another refinement, the perforated body may be frusto-conical in shape and a diameter of the perforated body may increase in an axial direction from fore to aft.

In another refinement, a fore end of the perforated body may be downstream to an eductor of the auxiliary power unit.

In another refinement, an aft end of the perforated body may be upstream of an exhaust silencer assembly of the auxiliary power unit.

In yet another refinement, the perforated body may decrease a velocity of the exhaust airflow.

According to another embodiment of the present disclosure, an auxiliary power unit is disclosed. The auxiliary power unit may comprise an engine casing, and an exhaust housing downstream of the engine casing, the exhaust housing including a perforated section for mixing ambient air with an exhaust airflow.

In a refinement, the perforated section of the exhaust housing may have a plurality of holes extending from an outer surface of the exhaust housing to an inner surface of the exhaust housing.

In a related refinement, the plurality of holes may be arranged uniformly around a circumference of the perforated section in at least one row.

In another refinement, the perforated section may decrease a velocity of the exhaust airflow and increase an eductor performance of the auxiliary power unit.

In another refinement, the perforated section may be located at an aft end of the exhaust housing.

In another refinement, the exhaust housing may have an outlet connected to an inlet of an exhaust silencer assembly.

In another refinement, the auxiliary power unit may further comprise an eductor upstream of the perforated section.

According to yet another embodiment of the present disclosure, a method for reducing noise in an auxiliary power unit is disclosed. The method may comprise directing an exhaust airflow out of a turbine section of the auxiliary power unit and into an exhaust housing, and mixing ambient air with the exhaust airflow through the use of a perforated section of the exhaust housing to decrease a velocity of the exhaust airflow.

In a refinement, the method may further comprise mixing ambient air with the exhaust airflow by providing the perforated section with a plurality of holes extending from an outer surface of the exhaust housing to an inner surface of the exhaust housing.

In a related refinement, the mixing of the ambient air with the exhaust airflow may occur through the plurality of holes in the perforated section, the plurality of holes arranged uniformly around a circumference of the perforated section in at least one row.

In another refinement, the method may further comprise directing airflow out of an eductor of the auxiliary power unit and into the exhaust housing.

In yet another refinement, the method may further comprise directing the exhaust airflow and ambient air mixture to an exhaust silencer assembly.

These and other aspects and features of the disclosure will become more readily apparent upon reading the following detailed description when taken in conjunction with the accompanying drawings. Although various features are disclosed in relation to specific exemplary embodiments of the invention, it is understood that the various features may be combined with each other, or used alone, with any of the various exemplary embodiments of the invention without departing from the scope of the invention.

### BRIEF DESCRIPTION OF THE DRAWINGS

FIG. 1 is a top schematic view of an aircraft tail section with an auxiliary power unit according to one embodiment of the present disclosure;

FIG. 2 is a cross-sectional view of part of the auxiliary power unit of FIG. 1;

FIG. 3 is a perspective view of an exhaust housing of the auxiliary power unit of FIG. 1; and

FIG. 4 is a flowchart outlining a method for reducing noise in an auxiliary power unit, according to another embodiment of the present disclosure.

While the present disclosure is susceptible to various modifications and alternative constructions, certain illustrative embodiments thereof, will be shown and described below in detail. It should be understood, however, that there is no intention to be limited to the specific embodiments disclosed, but on the contrary, the intention is to cover all modifications, alternative constructions, and equivalents along within the spirit and scope of the present disclosure.

### DETAILED DESCRIPTION

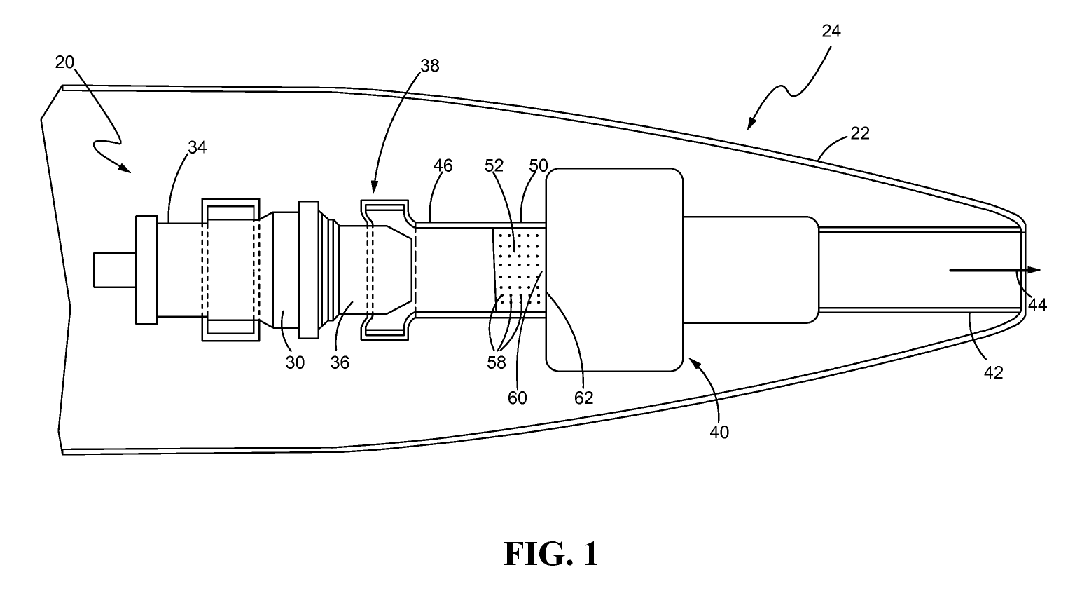

Referring now to the drawings, and with specific reference to FIGS. 1-3, in accordance with the teachings of the disclosure, an exemplary auxiliary power unit (APU) 20 is shown within an exterior structure 22 of an aircraft tail section 24. The APU 20 may generally include a compressor section 26 where air is pressurized, a combustor section 28 downstream of the compressor section which mixes and ignites the compressed air with fuel and thereby generates hot combustion gases, and a turbine section 30 downstream of the combustor section 28 for extracting power from the hot combustion gases. Compressor section 26, combustor section 28, and turbine section 30 comprise a gas turbine engine that may operate to provide mechanical input via shaft 32 to various components, such as an electrical generator (not shown). An engine casing 34 may enclose compressor section 26, combustor section 28, and turbine section 30.

APU 20 may also include an exhaust diffuser 36 downstream of the turbine section 30, an eductor 38 that extends annularly around at least a portion of exhaust diffuser 36 and draws cooling air into the APU 20 to mix with the combustion gases, and an exhaust silencer assembly 40 configured to attenuate the noise of APU 20 and disposed downstream from eductor 38 and exhaust diffuser 36. An exhaust pipe 42 may be disposed downstream from the exhaust silencer assembly 40, and may provide a channel for expelling exhaust gases from aircraft tail section 24. The term “downstream” is used herein with reference to the direction of the combustion gas flow from APU 20, as represented by directional flow arrow 44 in FIG. 1.

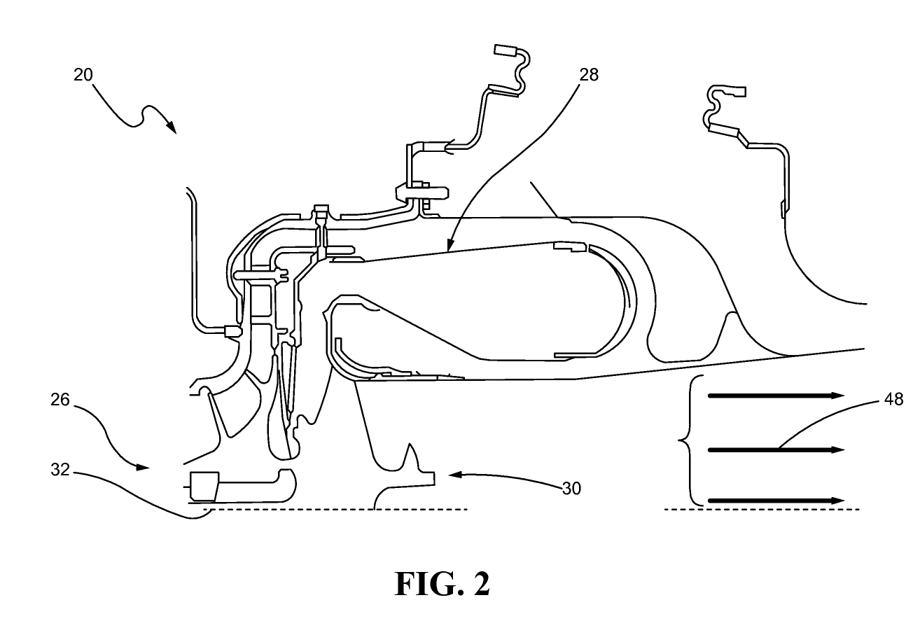

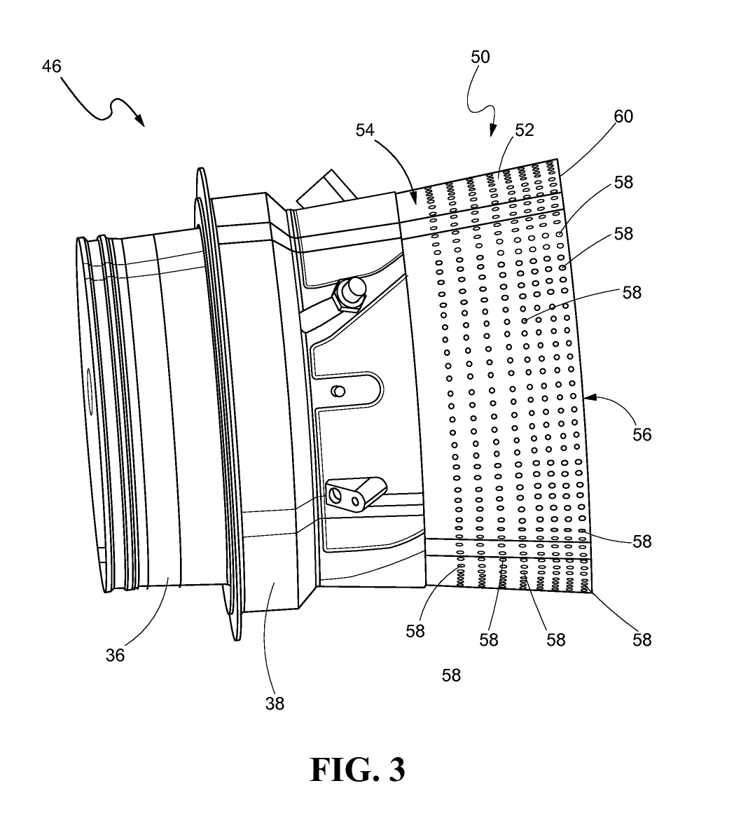

Downstream of the engine casing 34, APU 20 may have an exhaust housing 46 surrounding an exhaust airflow (depicted by arrows 48 in FIG. 2) exiting the turbine section 30. Downstream of the turbine section 30, exhaust diffuser 36, and eductor 38, and upstream of the exhaust silencer assembly 40, exhaust housing 46 may have a perforated section 50 at an aft end of the exhaust housing 46. The perforated section 50 may have a body 52 that is generally cylindrical or frusto-conical in shape with an increasing diameter in an axial direction from fore to aft. While the angle of convergence of the frusto-conically shaped perforated section 50 is depicted in FIG. 3 as a certain angle, it is to be understood that other angles of convergence are possible within the teachings of this disclosure. The body 52 may have an outer surface 54, an inner surface 56, and a plurality of perforations or holes 58 through which ambient air passes to mix with the exhaust airflow within the exhaust housing 46. The plurality of holes 58 may extend through the body 52 from the outer surface 54 to the inner surface 56 and may be arranged uniformly around a circumference of the body 52.

Moreover, while a series of eight (8) different annular arrays of holes 58 are depicted in FIG. 3, it is to be understood that any number of annular arrays, more or less than eight, may be used. Furthermore, the holes 58 need not be uniformly spaced and axially aligned as in FIG. 3, but rather could be otherwise provided. The holes 58 of the perforated section 50 admit ambient air from outside the exhaust housing 46 to penetrate all sides of the exhaust airflow in a radially inward direction. The exhaust housing 46 may also have an outlet 60 connected to an inlet 62 of the exhaust silencer assembly 40. In so doing, ambient air is allowed to gradually mix with the exhaust airflow, thereby causing a decrease in velocity of the exhaust airflow. The decreased velocity of the exhaust airflow results in an increased eductor performance of the APU 20. In addition, by reducing the velocity out of the exhaust housing, the noise levels created by the exhaust are decreased. By placing the perforated section 50 of the exhaust housing 46 upstream of the exhaust silencer assembly 40, the noise levels may further be attenuated by the exhaust silencer assembly 40 downstream.

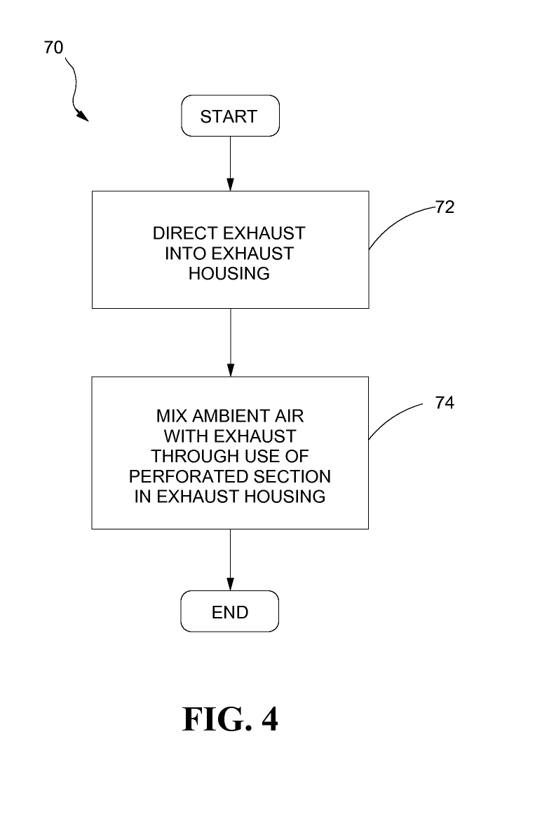

Turning now to FIG. 4, with continued reference to FIGS. 1-3, a process flow outlining a method 70 for reducing noise in the auxiliary power unit, according to another embodiment of the present disclosure, is shown. At block 72, exhaust airflow may be directed out of the turbine section 30 of the APU 20 and into the exhaust housing 46. At block 74, ambient air may be mixed with the exhaust airflow through the perforated section 50 of the exhaust housing 46.

### INDUSTRIAL APPLICABILITY

From the foregoing, it can be seen that the teachings of this disclosure can find industrial application, technical effects and benefits in any number of different situations, including but not limited to, reducing noise outputs and increasing eductor performance of auxiliary power units and gas turbine engines. Such engines may be used, for example, on aircraft for generating thrust, or in land, marine, or aircraft applications for generating power.

The disclosure described provides a perforated section for an exhaust housing of an auxiliary power unit. By incorporating a perforated section into the exhaust housing downstream of a turbine section and downstream of an eductor, ambient air is allowed to gradually mix with an exhaust airflow, thereby causing a decrease in velocity of the exhaust airflow. By decreasing the velocity of the exhaust airflow over a length of the perforated ring, this results in an increased eductor performance of the auxiliary power unit. In addition, by reducing the velocity out of the exhaust housing over a greater period of time, the noise levels created by the exhaust are decreased. By placing the perforated section of the exhaust housing upstream of the exhaust silencer assembly, the noise levels may further be attenuated by the exhaust silencer assembly downstream. Thus, a more effective way to reduce noise levels in an auxiliary power unit is disclosed.

While the foregoing detailed description has been given and provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims appended hereto.

What is claimed is:

1. An exhaust apparatus for an auxiliary power unit comprising:
an exhaust housing including a perforated body surrounding an exhaust airflow of the auxiliary power unit, the perforated body including:
an outer surface,
an inner surface, and
a plurality of holes through which ambient air passes to mix with the exhaust airflow, the plurality of holes extending through the body from the outer surface to the inner surface.

2. The exhaust apparatus of claim 1, wherein the perforated body is generally cylindrical in shape.

3. The exhaust apparatus of claim 1, wherein the plurality of holes are arranged in at least one row around a circumference of the perforated body such that the at least one row admits ambient airflow to penetrate all sides of the exhaust airflow, each of the plurality of holes providing the ambient airflow in a radially inward direction.

4. The exhaust apparatus of claim 1, wherein the perforated body is frusto-conical in shape and a diameter of the perforated body increases in an axial direction from fore to aft.

5. The exhaust apparatus of claim 1, wherein a fore end of the perforated body is downstream to an eductor of the auxiliary power unit.

6. The exhaust apparatus of claim 1, wherein an aft end of the perforated body is upstream of an exhaust silencer assembly of the auxiliary power unit.

7. The exhaust apparatus of claim 1, wherein the perforated body decreases a velocity of the exhaust airflow.

8. An auxiliary power unit comprising:
an engine casing; and
an exhaust housing downstream of the engine casing, the exhaust housing including a perforated section for mixing ambient air with an exhaust airflow.

9. The auxiliary power unit of claim 8, wherein the perforated section of the exhaust housing has a plurality of holes extending from an outer surface of the exhaust housing to an inner surface of the exhaust housing.

10. The auxiliary power unit of claim 9, wherein the plurality of holes are arranged uniformly around a circumference of the perforated section in at least one row.

11. The auxiliary power unit of claim 8, wherein the perforated section decreases a velocity of the exhaust airflow and increases an eductor performance of the auxiliary power unit.

12. The auxiliary power unit of claim 8, wherein the perforated section is located at an aft end of the exhaust housing.

13. The auxiliary power unit of claim 8, wherein the exhaust housing includes an outlet connected to an inlet of an exhaust silencer assembly.

14. The auxiliary power unit of claim 8, further comprising an eductor upstream of the perforated section.

15. A method for reducing noise in an auxiliary power unit, comprising:
directing an exhaust airflow out of a turbine section of the auxiliary power unit and into an exhaust housing; and
mixing ambient air with the exhaust airflow through the use of a perforated section of the exhaust housing to decrease a velocity of the exhaust airflow.

16. The method of claim 15, further comprising mixing ambient air with the exhaust airflow by providing the perforated section with a plurality of holes extending from an outer surface of the exhaust housing to an inner surface of the exhaust housing.

17. The method of claim 16, wherein the mixing of the ambient air with the exhaust airflow occurs through the plurality of holes in the perforated section, the plurality of holes arranged uniformly around a circumference of the perforated section in at least one row.

18. The method of claim 16, further comprising directing airflow out of an eductor of the auxiliary power unit and into the exhaust housing.

19. The method of claim 16, further comprising directing the exhaust airflow and ambient air mixture to an exhaust silencer assembly.
